(19) United States
(12) Patent Application Publication
(10) Pub. No.: US 2012/0038665 A1
(43) Pub. Date: Feb. 16, 2012

(54) SYSTEMS AND METHODS FOR GRAPHING USER INTERACTIONS THROUGH USER GENERATED CONTENT

(75) Inventor: Jonathan Strietzel, Lakewood, CA (US)

(73) Assignee: H8it Inc., Lakewood, CA (US)

(21) Appl. No.: 13/210,339

(22) Filed: Aug. 15, 2011

Related U.S. Application Data
(60) Provisional application No. 61/373,826, filed on Aug. 14, 2010.

(51) Int. Cl. G09G 5/377

(52) U.S. Cl. 345/629

(57) ABSTRACT

A method for creating user generated content, comprises selecting content; placing a marker on the content; adding custom content to the marked content; and storing the content, marker and custom content as user generated content.

### RELATED APPLICATIONS INFORMATION

This application claims the benefit under 35 U.S.C. §119(e) of U.S. Provisional Application Ser. No. 61/373,826 filed Aug. 14, 2010 and entitled “Method and Apparatus for Obtaining Social Graph Data and User Opinions Over the Internet,” which is incorporated herein by reference in its entirety as if set forth in full.

### BACKGROUND

1. Technical Field

The embodiments described herein are related to sharing user generated content in a social networking environment, and more particular to tracking and graphing user's reactions to various interactions.

2. Related Art

More and more of the world's economy and interactions are taking place online. At the center of this transformation is the advent of the social network. These networks allow large groups of people from all over the world to come together and share interest, experiences, feedback, etc. Now even the different social network are interlink such that users bases from one network can easily share information and content with user bases of other networks.

As a result, it is possible to look at the links between a large cross section of individuals, whether these links be actual connections, similar interests, common friends or contacts, geographic, etc. These links can be “graphed” and then analyzed. For example, advertisers are always looking for better ways to target advertisements to online users. Thus, such a graph could be used to identify users with similar interests in order to target advertisements.

Typically, however, the mindset is to try and group individuals by interests and likes so that information and content of interest to them can be targeted for them. But this type of “positive” information, i.e., likes, interests, etc., can be deceiving when gathered online. On significant problem is that online users tend to resist providing positive feedback. For example, few users will take the time to fill out a survey or respond to a poll in order to let someone now they liked something. Further, users will tend to overstate how much they like something because they do not want to “hurt someone's feelings” or because they think that they should like something. Moreover the way in which feedback is requested online is disjointed and may produce skewed results and data that is difficult to compare.

### SUMMARY

Systems and methods for providing a social networking platform that is built around providing ratings for content and experiences is provide herein.

According to one embodiment, a method for creating user generated content, comprises selecting content; placing a marker on the content; adding custom content to the marked content; and storing the content, marker and custom content as user generated content.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example system in accordance with one embodiment;

FIGS. 2-4 are flow charts illustrating example methods for interacting with the system and creating UGC; and

FIG. 5 provides a series of screen shots that illustrate one example process for creating UGC using a mobile device.

### DETAILED DESCRIPTION

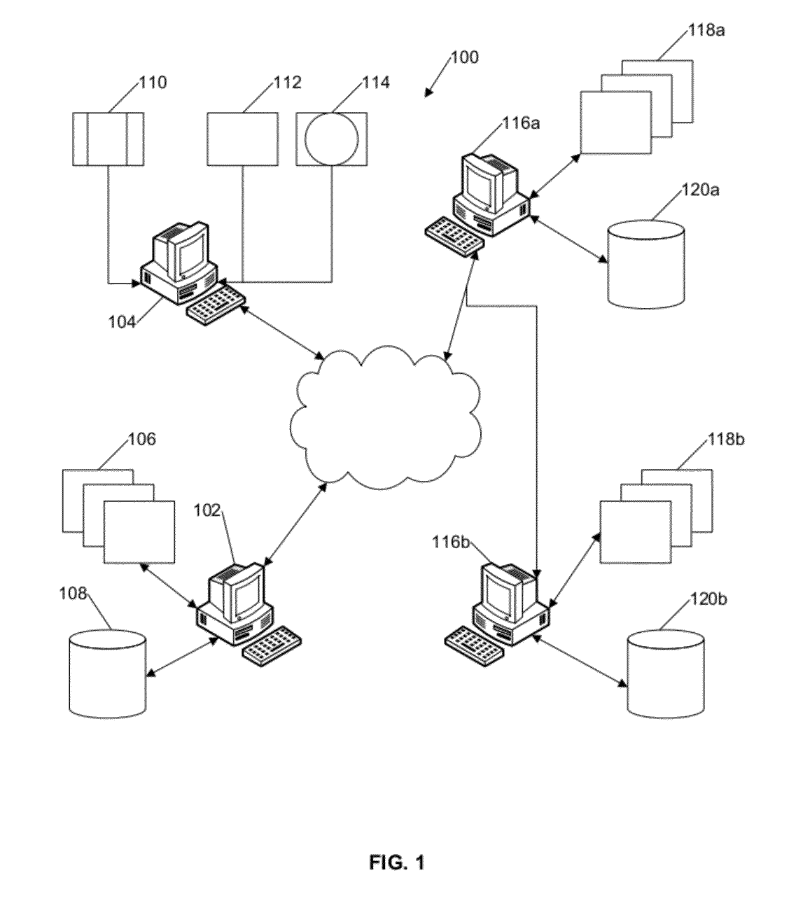

FIG. 1 is a block diagram illustrating an example system 100 for tracking user interactions and feedback in accordance with one embodiment. As can be seen, system 100 comprises a server 102 configured to host a web page or pages through which the systems and methods described herein can be carried out. A user can access server 102 through a network 115, such as the Internet or World Wide Web, using a terminal 104. As described in more detail below, the user can access content, either created by the user or accessed, e.g., via the Internet, mark with various markers, and then provide user create content. This information, i.e., the content, markers, and user created content can then be provided to server 102.

In certain embodiments, each user can have a profile page, blog, channel, etc., 106 on the site hosted by server 102. Server 102 can also be coupled with database(s) 108 configured to store the data provided by the users.

In certain embodiments, the user's terminal 104 can comprise or include a special application, program or browser 110 that allows the user to access content on the we, e.g., on other social networking sites, blogs, retail pages, etc., and mark the content displayed thereon. Thus, for example, if a user access a fashion retailer's page and likes certain shoes displayed thereon, the browser or application 110 allows the user to mark the shoes on the page and provide positive comments. This information can then be provided with store location information where the shoes can be purchased as well as other information as described in more detail below.

In addition, the user may generate content, mark it, and provide further information. For example, if they just ate at a restaurant the user can take a picture, using their mobile phone 112 or camera 114, provide a rating, and location information and upload it to their page or blog 106. In certain embodiments, of course, the user can access server 102 using their mobile device 112. In fact, terminal 104 can be a computer such as a laptop or desktop computer, or a portable computing device, such as a tablet, cell phone, smart phone, personal digital assistant, etc.

Also illustrated in FIG. 1 are several servers 116a-116b configured to host a provide content. Thus, the servers 116a-116b can be configured to host pages or profiles 118a-118b that can include or provide various content. Servers 116a-116b can also be interface with various databases 120a-120b to store information, etc.

It will be understood that term server can refer to all of the hardware and software systems needed to implement the systems and methods described herein. As such, it will be understood that the term server can refer to multiple servers, routers, user interfaces, programs, applications, API's, etc., and that these components can be located in one location or multiple locations.

Once the content is uploaded, i.e., content with markings and user generated content, then other users can access it and, in certain embodiments add onto it. For example, they can provide their own experiences, ratings, rankings, reactions, etc. In certain embodiments, the feeds or blogs 106 can go viral by allowing them to be exported to other social networking sites and pages. For example, a user can export their feed 106 to their Facebook page; they can export video content with markers and content to YouTube, etc. In other embodiments, other websites an pages can have a toolbar that allows a user to quickly generate content by clicking on a icon or button. This will cause the program or browser to launch and allow the user to quickly mark the content and add comments and other content and to then upload it to server 102.

In certain embodiments, the user generated content includes an indication that the user does not like the content. Thus, the toolbar or icon mentioned above can include, e.g., a H8it™ button that user can click on to quickly mark the content and provide details or information as to why they do not like the content. As mentioned above, users are often more inclined to provide their view, and to be more honest and forthcoming when they do not like something.

As the content, feed, blog, etc., is accessed and exported to other sites, and as content is added to it, then one can start to determine links, commonalties, likes and dislikes, among a wide range of users. In this way, graphs can start to be constructed and analyzed based on the generation of content described herein. The remaining description will provide more detail of the systems and methods described herein.

As mentioned, certain examples herein pertain to a service that focuses on, but is not limited to, the negative aspects of a specific location, geographic area, products, people, activities, news media or services. In utilizing the system 100, a user uniquely creates a piece of User Generated Content (UGC) by marking a piece of content adding comments to or other information to it and then broadcasting the UGC to different storage and distribution locations on, e.g., the internet.

The terms mark, marking, and marker pertain to any non-visual or visual icon, in code, or displayed and represented in 20 or 3D to a user of system 100 and that can signify a location (coordinates in 20 or 3D space) of interest.

The term content pertains but is not limited to any text, image, video, audio, GPS location, 20 object or 3D object that is pre-existing and is marked and enhanced by a user of system 100.

UGC pertains but is not limited to unique user generated content such as text, image, video, location, 20 or 3d object or audio that can stand alone or that can be attached or added to an existing content item thereby personalizing the content further before and even after initial distribution. UGC also relates to the combination of any of but not limited to the user generated content types listed above.

The term system relates to the entire software and hardware therein, and apparatus that records user created or marked content (marker), all of the UGC therein and the methods it uses to store and distribute the UGC to the appropriate locations on the internet.

In certain embodiments, system 100 also includes a robust advertising engine, rich data mining and analytics engine that runs behind the scenes, e.g., on server 102, collecting and aggregating all of the various pieces of data that is generated within system 100 in accordance with the systems and methods described herein for use in advertising, reporting and analytical products.

The term site relates to the main business and social networking website that users can interface with to utilize the systems and methods described herein. The site could take the form of a standard website, a mobile site, or a 3D interactive environment that acts and contains the basic functionality contained in a standard web page. The site can also contain all of the expected social networking functions that currently exist such as but not limited to: user profiles, friends lists, account settings, search capability, blogs, groups, rewards, rankings, monetization means, virtual currency, forums, videos, content uploading, content tagging, UGC capabilities, inbox mail functionality and advertising capabilities as well as advanced advertising services, analytics and metrics access for business users.

As noted, the UGC in the system can be completely original vs. the users commenting and adding UGC to pre-existing content. For example a user might decide to comment about an experience they had. They would input the commentary in text, image or video form and submit that UGC to server 102 as a unique piece of media, which would then be displayed in their feed 106 and forwarded to all of the necessary storage and distribution locations 108, 116 over the internet. From there, the media can be considered UGC and it would be enhanceable by other users of system 100 going forward.

system 100 can use unique markers that are set by users onto or into various forms of content. The marker can include flags that have the functionality to allow the user to insert and attach new UGC. For example, a marker that is placed by the user on the content would lock into place. The systems and methods described herein then allow for the insertion of UGC to enhance the marker. For example if the marker was being placed onto something the user did not like on a web page, the user would set the marker and could enhance the marker by inserting negative commentary into the text field or by adding an audio or image video to the marker. This UGC would now be added to the marker and passed along with the URL and the flags that contain the location on the content on the page.

Server 102 can then store and distribute the content to the appropriate places on the internet.

A user can install a web-browser plugin 110 that allows them to drag a marker to various areas on a web-page set it, and lock it into place over the content. The software installed in the browser would record the URL of the webpage, calculate the position of the marker by utilizing a number of different unique marker locator methods including but not limited to the markers HTMUCSS coordinates and/or background and pixel layout (The pixel combination that lays behind where the user placed the marker) it would then aggregate any other UGC provided by the user after the initial marker placement, save and distribute that information to the appropriate storage and distribution locations on the Internet.

Upon viewing the marker, other users could add new UGC elements to the marker even though they are not the original creator of the marker.

The use of a custom web browser can also be employed which contains all of the necessary software to make systems and methods described herein work. An entire and custom web browser can be created for install or download that would enable a user to perform all of the necessary steps to appropriately mark and add UGC to content viewable through a web browser online. This web browser can be optimized specifically for the system.

In other embodiments, capturing web pages or content inside of an iFrame can also prove to be a great method for allowing users to freely mark content as opposed to a web browser plugin or through the use of a unique web browser. The iFrame method allows complete control of the user experience. Essentially the users can view content through an iFrame and have the ability to mark content items as described above.

Right-Click marking can also be an effective means for marking content. For example, upon coming to an area in an image, an area of text or a frame of video, for example, a user could “Right-Click” or perform some sequence of clicks to target an area on or around content, effectively marking the content. The system would record where the user “Right-Clicked” and mark the content through a number of methods some of which, but not limited to, CSS/HTML location on the page, pixel layout behind the marker, 3d coordinates in a 3d space, save that marker location info into the database along with a URL and any extra/added UGC. The Click method can require some sort of install on the users local machine 104 in order to enable the functionality for use with a mouse, trackpad or other devices.

Touch computing marking can also be used for marking content. By touching an area on screen or by executing some sequence of touches, UGC can be created and attach to the area on the screen that they designated. For example, the users that use touch-based mobile phones, tablet PCs, and touch screen monitors would all utilize a system like this.

Although it is close to touch, gesture-based marking in 2D or 3D space can also be employed. The user can point to an area of interest, perform some sort of trigger gesture or combination of gestures that append the mark to the area of interest. From there the marker can be expanded upon by adding UGC. The system can record where the user performed the appropriate gesture in 2D or 3D space, correlate that information with necessary, and save that location data into the database along with all of the UGC added to the marker.

In every example a user is providing some form of opinion about something including but not limited to internet articles, pictures, locations, audio bits, video and much more. Once the users opinion is expressed in one of these forms, the desire to express this opinion should be shared in as many ways as possible. Thus, as noted, server 102 can be interfaces with many social networking services via their API's. For example, if a user were to post a text based dislike for a product or service, the user would more than likely want the dislike to be broadcast over the Internet through every social networking means possible. In this case the user would broadcast their text-based dislike and it would automatically be posted to Twitter, Facebook and other services that the user has chosen to link his account to. Once posted on these destinations, the viewers of these posts could also click links or urls that allow them to come and sign up for the service. This is an example of the type of viral spread that will be a result of a users UGC.

As users utilize the systems and methods described herein, they will start to collect and produce a lot of data in the form of images, text strings, video snippets, audio and more. When possible, server 102 can distribute that data out to businesses that specialize in the storage of those certain types of media. While it is completely feasible to host all of that data, it is much more economical to store heavy data such as video or images on sites that welcome that storage such as YouTube or Flickr and retrieving them upon user request when it is needed. This will avoid costly server and storage costs of the data and limit its bandwidth going to and from the network.

Hosting all of the data that is generated by the users, as stated above is also feasible. This would require massive databases, hardware storage and bandwidth. While this is not ideal, this is certainly a way to deploy the systems and methods described herein without having to worry about the “up time” of another companies service.

The systems and methods described herein provide a means for users to express satisfaction or dissatisfaction with products or services via an internet enabled device. Server 102, or algorithms running thereon allow the aggregation of all of the user data into compiled reports that allow other business or advertisers to understand the “Social Graph” of the internet better and more effectively. The algorithms can not only be a user end application but can provide businesses and relevant parties rich access to all of its collected user data, neatly compiled into reports of many types. For example, a company can aggregate all of our users data in the mobile phone market and have a report generated based on users comments and actions within that vertical. This report would be of substantial value to businesses in the mobile phone space, telecom space, mobile games space, device manufacturing space etc.

In certain embodiments, the reports generated can be interactive, generating data requested in aggregate form on the fly and such that it can be displayed in any of, but not limited to the following forms, a 3d model, 2d graph or image, text based report, spreadsheet format, audio format, video format or a hologram/3d representation of the aggregate data. Each of these formats can be combined with another to provide a completely interactive data mining and report generating exercise. The report generation can be done in the form of traditional mouse on screen computing, touch computing (mobile or touch based computing devices), audio commands or through the use of gestures.

Users of system 100 can have the ability to generate a profile which would represent them on the site and that can be accessible through search or other methods. The profile in the site could use intelligence to auto generate more effective profiles and meta data based on, but not limited to, their use of the system, their friends, their UGC, etc., which would provide a better recommendation engine and user matching system overall.

Mobile applications can also be supported that allow users to access UGC. For example, the mobile application can be fairly straight forward, providing users the option of selecting to post a text dislike for example about a product or service, they can use the camera on the phone to take an image of something they dislike and post it, they could shoot video, submit an audio commentary or file of some sorts, or tag their location using their GPS on the device and discuss that location.

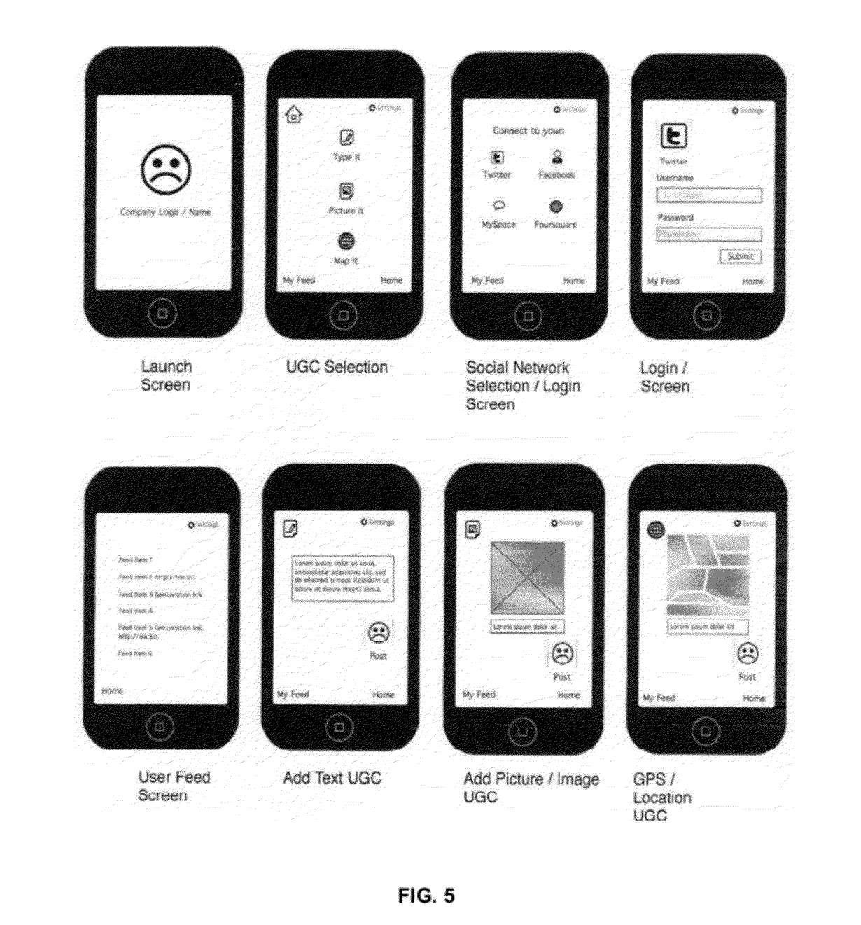

FIG. 5 provides a series of screen shots that illustrate one example process for creating UGC using a mobile device. First, the user can launch the UGC application. Then they can select what type of UGC they will create. Then they can access a certain site, such as a social networking site, log into the selected site, and view their feed. Next they can add text, a picture or image, a GPS location, or some combination thereof and post the UGC.

Combining these elements into a post that is richer in nature should always be considered. For example, posting a picture of some bad food you just ate along with a text string or audio string saying “This food was terrible”. Another example would be placing a GPS tag, in which you flagged the physical location of a store, for example, in your local mall. One could then append a picture they took. One could also then take this Geotag or location-based flag, add UGC and post it and share it over the web. The information and data would be stored and distributed by server 102 to all of the appropriate destinations on the Internet.

Each user that signs up can have a “feed” 106, which can be similar to the text based feed coming from users of many social networking sites that want to post their current “status” or what they are currently doing. For example, the users disgust for products and services can be displayed in a time-based format with the relevant media attached to each post. The user feed can display standard profile elements but not limited to things such as a profile picture, pictures in an album, would allow them to change the background of the feed, description of themselves, links to favorite places on the web or their personal website(s), their friends, their favorite feeds posted by their friends, a settings area where they can filter feeds of interest and much more. A user should be able to search for other users within the network, view and subscribe to their feeds.

Inside of system 100 the targeted advertising opportunity is abundant. The current system 100 can support the targeting of advertising based off of many factors but not limited to feed data, time of the posts, location of the user, keywords in the post, user profiles, time of day, computer based or user tagged images.

Making money off of affiliate marketing through certain keywords posted, images posted or video or even locations that are posted is a big deal. Once the data is in system 100 it can be push to users suggestions based on the data that they are inputting, thereby generating affiliate marketing dollars.

The systems and methods described herein can be configurable by the administrators or users so that certain feeds, UGC or posts are forwarded to any destination on the web automatically and in any format needed. For example, server 102 can automatically email multiple addresses on the web, alerting users of the relevant posting that has occurred. A link can be provided so that viewers of the email can view the post directly, comment or interact by but not limited to posting their own text, images, video, location or a combination of any of thereof.

The systems and methods described herein generate revenues in many different ways, one example would be users paying for enhanced or special posts of UGC, for example, a user might pay extra in the form of local site currency or credits or small amounts of cash to have their UGC post have more relevance than the average post.

In one implementation it an incentive to paying for enhanced posts might be a revenue distribution model whereby when a user pays for the enhanced UGC post, a portion of their payment is distributed to, for example, a charity or another business. Another example would be that the user that pays for enhanced UGC placement would be the recipient of site specials and promotions based on their spending.

Rewards can also be granted in the form of titles for it's most active and relevant users both standard and business user accounts. For example, a user can earn the title of “super user” and be assigned some special icon for their value contributions that would be displayed to the user community as a status symbol. A user may also win currency, points or some other form of value based on the value they generate in the system. A multi-tiered ranking system is also feasible where there would be multiple tiers based on a users activity and value generation inside the system.

Users can be group together by creating groups inside of the site or system and generate rewards based on the groups activity as a whole. The group function could be used to coordinate events and to collect and generate massive amounts of UGC in a specific location using technologies such as GPS to coordinate the event. For example, but not limited to, a concert, sporting event, protest and rally.

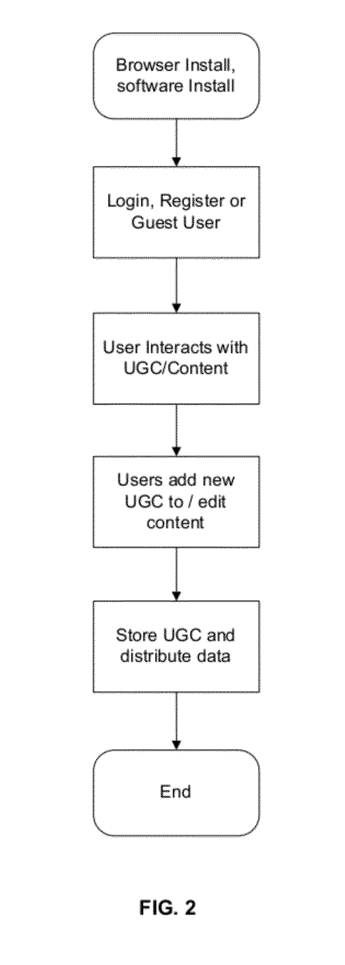

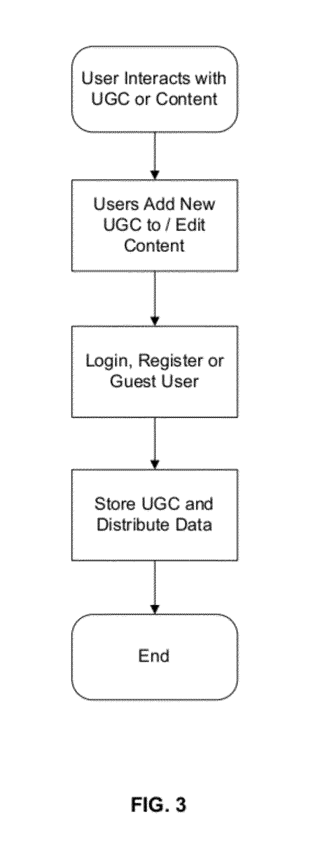

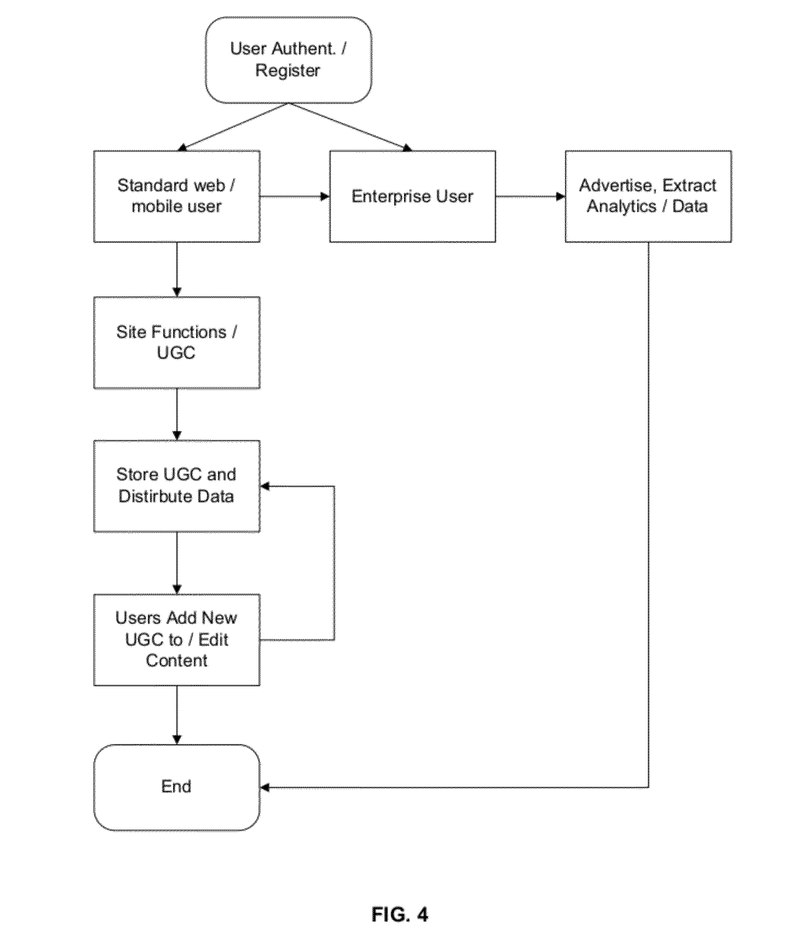

FIGS. 2-4 are flow charts illustrating example methods for interacting with the system and creating UGC.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A method for creating user generated content, comprising:
selecting content;
placing a marker on the content;
adding custom content to the marked content; and
storing the content, marker and custom content as user generated content.

2. The method of claim 1, wherein the custom content is at least one of text, pictures, video, and a GPS location.
